(19) United States
(12) Patent Application Publication
(10) Pub. No.: US 2020/0055488 A1
(43) Pub. Date: Feb. 20, 2020

(54) ADAPTATION IN TRANSMITTER DEVICES AND RADIO FREQUENCY RECEIVER AND METHOD OF TEMPORARY DATA CRYPTOGRAPHY FOR SYNCHRONY COMPARISON

(71) Applicants: Daniel Alberto Rezende, Pedreira (BR); Valter Viaro Junior, Pedreira (BR)

(72) Inventor: Daniel Alberto Rezende, Pedreira (BR)

(21) Appl. No.: 16/541,970

(22) Filed: Aug. 15, 2019

(30) Foreign Application Priority Data
Aug. 16, 2018 (BR) 102018016813-4

(51) Int. Cl. B60R 25/24; H04W 12/00; G06F 1/14; B60R 25/20; B60R 25/10

(52) U.S. Cl. CPC B60R 25/24; H04W 12/0017; B60R 2325/108; B60R 25/209; B60R 25/10; G06F 1/14

(57) ABSTRACT

In order to achieve a secure and inviolable encryption method of data to be transmitted via RF. To this end, a transmitting device (TD) and a receiving device (RD) each receive a high-precision real-time clock (RTC). The receiving device (RD) receives the registration of the transmitting devices (TD) through specific commands, opening a recording window in its firmware for the registration of a transmitting device (TD), performing automatic comparison of the difference between the received data—date, time, etc.—of this transmitting device (TD) with the data of its own RTC, storing it in the memory of the microprocessor (M) together with the serial number of the transmitting device (TD) compared. When the transmitting device (TD) is triggered to perform an action, the microprocessor (M) reads its RTC and encrypts the date and time data (D) (year, month, day, hour, minute, second) in single binary code, this being transmitted to the receiving device (RD), which microprocessor M performs the decoding of data D and compares it with the date and time (D data) of its own RTC by performing or canceling the action of the transmitting device (TD).

This report describes the invention for an adaptation made in transmitters and RF receiver devices, with a data encryption method provided by high-precision real-time clock (RTC) and sent by radio frequency signals from the transmitting device to the receiving device, also provided with RTC, for such data to be decoded and compared, allowing or denying the action imposed by the transmitting device, in a secure drive system and control mechanisms.

This method can also be implemented in PKES systems—in vehicle keys, in the vehicle itself or in another application—by unlocking approach safely and avoiding malicious persons, which is becoming frequent.

### DESCRIPTION OF THE STATE OF THE ART

As is well known, information security, for some time now, has gained prominence in projects and debates among entrepreneurs because the risk of leakage of organizational files is increasingly becoming significant. Because of this, data encryption is a more than urgent issue.

As is well known, computerization has brought countless advantages to contemporary society. Now, with just a few hits, you can virtually optimize a company's processes, control entry and exit of items, and evaluate results objectively. Technology, in fact, has facilitated the way the demands are solved today.

However, while the resources generated provide more agility and assertiveness in the tasks of any enterprise, devices and mechanisms, there are those who promote a real terror by capturing encrypted data, theft of confidential references and performing various frauds and violations.

In short, data encryption is the method used to protect information, thus preventing it from falling into the wrong hands. That way, only the interested people can access them, that is, only the receivers can decode them.

At the beginning of the digital age, the combination was made using only one code, which made the process susceptible to invasions because if someone unauthorized discovered such a formulation, the secret was at risk of being controlled by inappropriate people. Over time, the coding was improved and the first mechanism to emerge, after many attempts, was the 8-bit algorithm. It allowed for an arrangement of 256 possibilities. That is, security raised on a scale from 2 to 8. But that's not all. The tool has undergone changes, and today, you can obtain until 128 bits.

Data encryption ensures information security. That is, it is the current way of protecting, not only the organizational files, but also ensures that records and access data remain confidential.

It is also known to experts that Real Time Clock (RTC) is a real time clock with high accuracy and low power consumption. Its board features a built-in temperature sensor and a crystal oscillator to improve its accuracy. The DS3231 module, or another compatible/similar module, is capable of providing information such as seconds, minutes, day, date, month and year. Corrections such as months with less than 31 days and leap years are corrected automatically and can operate in both 12-hour and 24-hour format.

Three types of encryption are also known: the Learning Code or Fixed Code is a binary code emitted by the transmitter via radio frequency, usually at 433 mHz or 915 mHz, and as the name itself suggests the code is fixed, it never changes. Once recorded in the central receiver, it will always take action when the received code is identical to the recorded code; the Rolling Code or Jump Code is also a binary code emitted by its transmitters, and communication is also performed by radio frequency and usually in the frequency of 433 mHz or 915 mHz, however its code is encrypted and changes with each transmission, its receiver after receiving the code creates a logic to make sure the received code is the registered one; and Hopping Code, whose operation is similar to the Rolling Code, where the code is exchanged with each transmission, but its encryption was improved, raised to 128 bits, making it almost unbreakable.

However, the Fixed Code can be deciphered because of its immutability and, like its similar Rolling Code, the Hopping Code system can be circumvented using a clone (signal interceptor). Therefore, the three cited models of communication between transmitters and receivers are likely to have security vulnerability during communication, allowing third-party devices to intercept the code and clone it.

Finally, the acronym PKES is known, which stands for Passive Keyless Entry and Start. These systems allow you to unlock and start a vehicle based on the physical proximity of its respective key without user interaction with the system; that is, it just needs to carried. This system, although labelled commercially as a secure system, is vulnerable to attacks, since it is possible to use a low frequency amplifier to amplify the LF signal—between 100 and 130 KHz emitted by the vehicle, reaching the key that can be up to 100 meters away, unlocking the vehicle without the need to approach the key holder.

### OBJECTIVE OF THE INVENTION

In order to achieve a method of encrypting data to be transmitted via secure and tamper-proof RF, the inventor, using a high technical knowledge and an adaptation in simple devices, hereby proposes an innovative method of nonlinear encryption to be applied in devices of daily use, such as electronic gates, alarms, car keys with control, PKES systems in general, etc.

Thus, in a transmitting device and in a receiving device, equipped with microprocessor, is installed a device called “high-precision real-time clock (RTC)”, such as those of type CI DS3231 or other compatible/similar, which transmits date and time data (year, month, day, hour, minute and second). When a command is triggered, the microprocessor of the transmitting device uses the RTC data for performing the binary encryption pre-defined by a control center, sending such encrypted data by RF signal to the receiver, whose microprocessor performs the decoding of the signal and then makes a comparison with its own RTC, allowing or canceling the action of the control by the result of the comparison of the data.

### DESCRIPTION OF THE DRAWINGS

FIG. 1—schematic view of a diagram showing the data in dashed lines being emitted by the RTC of the transmitting device, encoded by the logic programming of its microprocessor and transmitted through its RF transmitter to the RF receiver of the receiving device, and it is, in turn, decrypted by the logic programming of the microprocessor of the latter, which performs the comparison of the data received with the data of its own RTC;

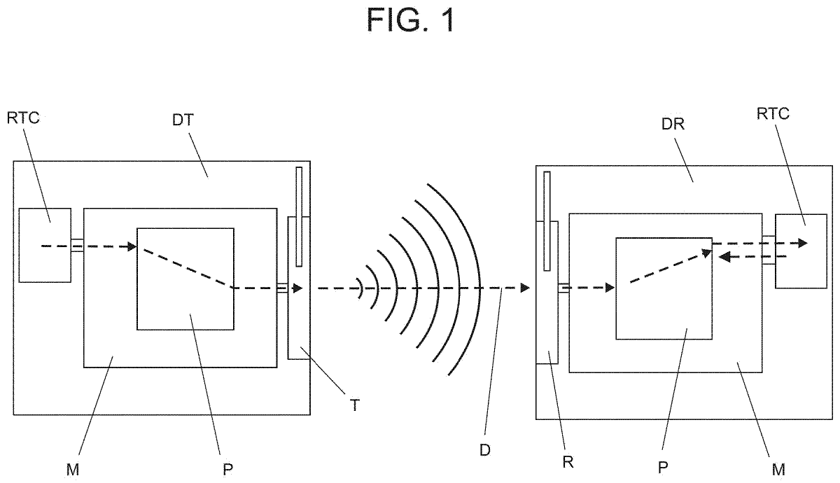

FIG. 2—shows the collected signal of a transmission of the technology to be described, the reason for this patent application.

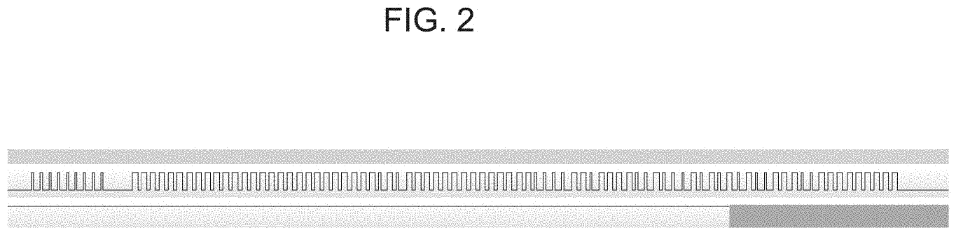

### DETAILED DESCRIPTION OF THE INVENTION

In conforming to the drawings presented, the adaptation in transmitter and receptor devices for radio frequency and method of cryptography of temporary data for comparison by synchrony, calls for an 84-bit encryption method in the transmission and reception of data in logical connection, especially via radiofrequency in simplex, directional, or half-duplex transmission, to be applied in diverse devices. The code passed by this method changes over time (date and time it is triggered) rather than binary logic, as with other technologies.

To that end, a transmitting device (TD) having an RF transmitter (T) and a receiving device (RD) having an RF receiver (R) having, in both (DT and RD), a microprocessor (M) with firmware and programming coding logic (P) of 84 bits with coding chosen by a control center, and a high-precision real-time clock (RTC).

Thus, after being manufactured and already properly installed in the respective device, the receiving device (RD)—which can be a receiver for electronic gates, automobiles, alarms, etc.—allows the registration of new transmitter controls—of transmitting devices (TD)—by manual procedure. Thus, through specific buttons and/or commands performed on the receiving device (RD) (predefined during its manufacture and depending on the device) a recording window is opened in its firmware for the registration of a transmitting device (TD), whereby the difference between the received data is automatically compared—such as date, time, etc.—of this transmitting device (TD) with the data of its own RTC. This time difference between both (TD and RD) is stored in the microprocessor memory (M) of the receiving device (RD), as well as the serial number of the transmitting device (TD) compared, as validation to accept commands from the respective transmitting device (TD) that has this particular serial number.

Its use will therefore be defined in this descriptive report as the control system for automatic gates, only as a practical example, and may vary widely depending on the purpose of the devices (TD and RD) receiving the described technology. In this example, the control receives the technology integrated into an RF transmitter (T), whereby the transmitting device (TD) and gate automator receives the same technology integrated into an FR (R) receiver, and therefore the receiving device (RD).

That said, when triggered the control (TD) in the direction of executing its command to open or close the gate, the microprocessor (M) reads its RTC and, from its logical programming (P), transforms the data (D) of date and time (year, month, day, hour, minute, second) in a single binary code, which will be transmitted through the RF transmitter (T). The emitted signal is then picked up by the automation (RD) RF receiver and transmitted to its microprocessor (M), which recognizes the serial number of the transmitting device (TD) and makes use of the code key in its logic programming (P) to perform the decoding of the binary code, i.e., the encrypted data (D). What then occurs is that the binary decoded code (the data (D)) is analyzed by the microprocessor (M) in order to compare it with the date and time (data (D)) of your own RTC, calculating the data difference (time) according to the serial number of the transmitting device (TD), as previously said.

As a result, if the RTC information of the receiving device (RD) is identical to that of the decrypted binary code of the received data (D) the action imposed by the transmitting device (DT) is accepted by the receiving device (DR), opening or closing the gate as in the previous example, as well as turning on or off a light bulb in the case of home automation lighting, activating or deactivating alarms in case of alarm systems, locking and unlocking a car door when applied in the control of its keys, finally, performing the due action of the type of device used.

If the data (D) of the received and decrypted code is not in accordance with the data (D) emitted by the RTC of the receiving device (RD), its action is canceled.

In the method described, the data (D) sent by the transmitting device (TD) alternates every second, because it is based on the date and time set by the RTC, resulting in a secure encryption that is difficult to breach, since even if an interceptor interferes and collects the data (D), the code will have no validity from the next second. The firmware of the receiving device (RD), because it allows a window for comparing the time difference between its RTC and the RTC of the transmitting device (TD), is able to validate its action, updating this difference, even in cases of controls—Transmitting Devices (TD)—which has been stored, i.e., inactive, for months or years.

In this way, the innovation and the breadth of possibilities of using this new method of data transmission (D) is obvious, via encrypted signals in a non-linear time logic, where such data (D) is updated in time synchronization in both transmitter (TD) and receiver (RD) devices, thus being inviolable, standing out in quality and simplicity of application when compared with the other commonly used methods.

That said, this method can also be used in devices with PKES system for vehicles. To this end, the receiving device (RD) is installed in the vehicle, emitting a constant wake-up signal together with the vehicle ID via LF radio frequency (low frequency—preferably between the frequencies of 100 and 130 KHz. Shortly after the last data is transmitted, the timed count starts by an internal oscillator waiting for a response from the transmitting device (TD), in this case the key. Thus, the key (TD) “awakens” and verifies that the ID is correct and, if yes, it queries your RTC and sends this data via UHF—at 433 mHz, 915 MHz or other frequencies. The receiving device (RD) of the vehicle, after receiving the last data, pauses the count, recognizes the serial number, decrypts the information and compares the data received with its own RTC, as described in the previous cases. If the data is correct and the count is within a stipulated time limit, it allows the activation of the alarm, the opening of the doors, the start of the vehicle or another command.

1- Adaptation on transmitters and receivers of radiofrequencies, consisting of a transmitting device (TD) equipped with a RF transmitter (T) and a receiver (RD) provided with an RF receiver (R), both (TD and RD) containing a microprocessor (M) with firmware and logic programming (P) of 84 bits with coding chosen by a control center, characterized by the devices (TD and RD) receive a high precision real time clock (RTC) each.

2- Time data encryption method for synchronisation comparison, according to the adapted devices (TD and RD) described in claim 1, after installed in their respective devices characterized by the receiving device (RD) receive registration of new transmitter controls—transmitting devices (TD)—manually by specific buttons and/or controls, opening a recording window in its firmware for the registration of a transmitting device (TD), automatically comparing the difference between the received data—date, time, etc.—of this transmitting device (TD) with their own RTC data, this time difference between both (TD and RD) stored in the microprocessor memory (M) of the receiving device (RD) together with the serial number of the transmitting device (TD) compared.

3- Method of time data encryption for synchronization comparison, according to claim 1, when the transmitting device (TD) is enabled to execute a command, characterized by its microprocessor (M) perform the reading of its RTC and, from the logical programming (P), encrypt the data (D) of the time and date of the action for its transmission together with its serial number through the RF transmitter (T) to the RF receiver (R) of the receiving device (RD), which microprocessor (M) recognizes the serial number and decodes the encrypted data (D) for comparison with the data (D) of its own RTC.

4- Method of time data encryption for synchronization comparison, according to claim 1, when employed the method in devices with PKES system for vehicles, characterized by the receiving device (RD) installed in the vehicle emits an alarm signal together with the vehicle ID via LF radiofrequency, initiating an internal oscillator timed count waiting for a response from the transmitting (TD) device that “awakens” and verifies the ID, by querying your RTC and sending this data along with your serial number via UHF so that the receiving device (RD) of the vehicle pauses the count and compare the data received with its own RTC, allowing to perform the action in case of agreement of the data.
